(19) United States
(12) Patent Application Publication
(10) Pub. No.: US 2002/0109053 A1
(43) Pub. Date: Aug. 15, 2002

(54) Nonslip surface for camera tripod panheads

(76) Inventors: Frank Robert Lemieux, Berlin (DE); Werner Michaeli, Wetzlar (DE)

Correspondence Address: FRANK LEMIEUX, POST FACH 45 03 53, BERLIN, D. 12173, DE

(21) Appl. No.: 09/781,481

(22) Filed: Feb. 11, 2001

(51) Int. Cl. F16M 11/04; G03B 17/00

(52) U.S. Cl. 248/187.1; 396/428

(57) ABSTRACT

A nonslip resilient surface on the camera attachment area of a camera panhead, which utilizes readily available o-rings (1) arranged concentrically about the camera attachment screw (1B). The depths of successive ring grooves can be graduated to allow for more protrusion of the outer o-rings to assure positive seating with the camera base (2). The resilient o-rings can be retained in their grooves by their own elasticity.

### FIELD OF THE INVENTION

This invention relates to the field of panheads used on photographic tripods and support devices, specifically to the nonslip surface on the top of the camera attachment plate of a panhead which protects the underside of a camera as well as prevents unwanted loosening of a camera to which it is attached.

### BACKGROUND-DESCRIPTION OF THE PRIOR ART

A non-slip protective surface is commonly provided on the camera attachment plate of photographic tripod panheads, to prevent the unintended loosening of the plate with respect to the camera, and so that the underside of the camera or other optical device does not become scratched upon contact with the plate. The non-slip protective surface is usually a thin sheet of precut resilient material such as cork or rubber, which is generally glued to the camera attachment plate upon manufacture.

This method of providing a non-slip surface is appropriate for traditional panhead designs where the attachment plate is drawn to the camera base without relative motion between the plate and the base during installation and removal, such as the case when there is a camera attachment screw separate from the panhead plate. In such a panhead, the resilient material is simply compressed in a linear manner as the separate camera screw is tightened, and a slip-resistant connection is thus achieved.

However, there are some drawbacks to this technique of providing a non-slip protective surface when, for example, the camera attachment plate and screw are formed as a unit and there is thus relative motion between the plate and the camera during installation and removal. Such integrated camera attachment screw/plate arrangements are often found on the circular camera attachment plates of panheads of the newer, “ballhead” type.

In such panheads, when the camera plate is tightened, the resilient material, which is moving relative to the camera bottom, begins to rub against and bind with the surface of the camera underside, effectively resisting full tightening of the plate against the camera. This is especially the case in regards to cameras with an uneven underside having dimples or protrusions. The nonslip resilient material may also easily catch on such uneven surfaces of the camera underside and tear during tightening and removal. Also, since the swept area of the nonslip surface is greater toward the outside of the circle, the material will tend to wear away at the outer areas first-over time this will produce an unstable rocking engagement between the camera and the panhead base attachment area as the outer surfaces will become lower than the inner surfaces. Furthermore, should the non-slip material need to be replaced, it must be stripped away and then correctly repositioned and reglued.

In addition to these drawbacks of the use of a resilient sheet, there are also some difficulties associated with its manufacture and installation. The resilient sheet must be cut to match the size and shape of the camera attachment area, and then accurately positioned and glued, and the assembly allowed to dry. These operations increase the cost of manufacture.

### OBJECTS AND ADVANTAGES

Accordingly, it is the object of the present invention to provide a non-slip surface for the camera attachment plate of photographic panheads:

which allows for secure and positive tightening of the attachment plate to the camera;

which uses standard, readily available materials;

which can be installed to compensate for uneven wear;

which need not be cut to fit attachment areas;

which need not be carefully positioned and glued to attachment area;

the components of which can be simply and easily replaced in case of wear, or to suit specific requirements or conditions.

In addition, it is another object of the present invention to provide a nonslip surface of attractive appearance.

### DESCRIPTION OF THE DRAWINGS

FIG. 1 shows a tripod panhead camera attachment plate (1A) of a tripod panhead (3) with three concentric o-rings (1) formed in its surface. Also shown is an integrated camera screw thread (1B), which screws into threaded tripod socket (2B) on the underside of camera (2)

FIG. 2 shows a partial sectional view of camera attachment plate (1A), showing a dimensional arrangement of successive o-ring grooves (1c) and the dimensional relationship of the grooves to the o-ring (1).

### DESCRIPTION OF THE INVENTION

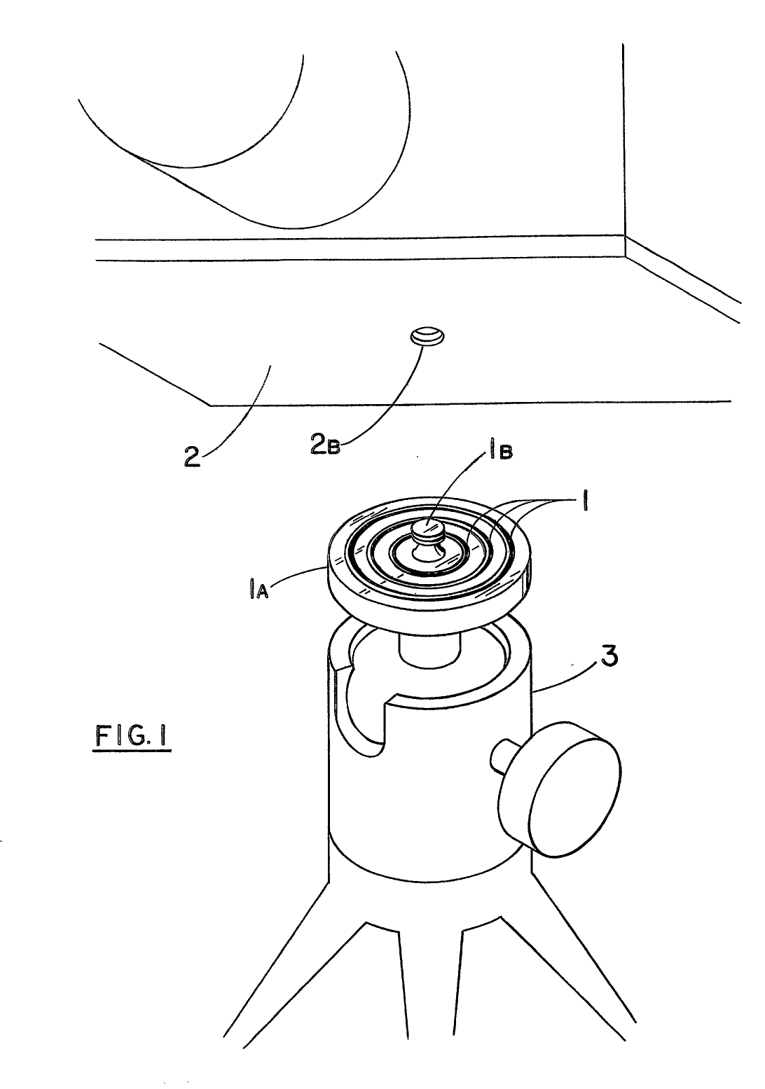

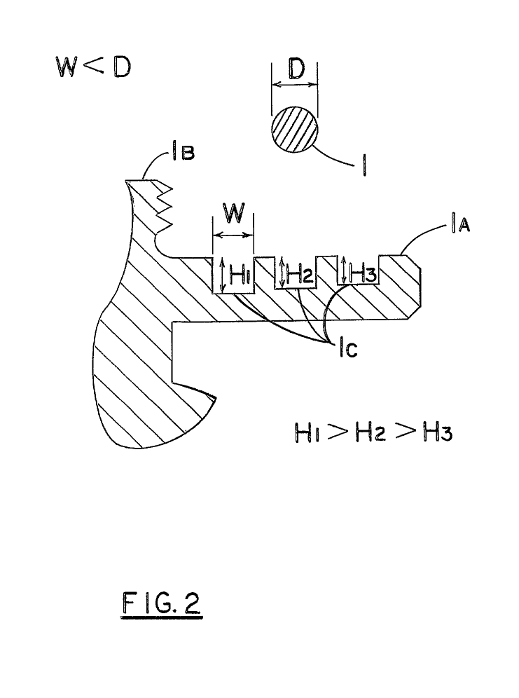

FIG. 1 shows a circular tripod panhead camera attachment plate (1A) with three concentric o-rings (1) retained in grooves (1c, see FIG. 2) formed in its surface. The grooves can be dimensioned to allow the use of standard available o-rings, and to allow for elastic retainment of the rings in the grooves. The depths of the grooves can also be formed to allow each successively larger o-ring to protrude further from the camera attachment plate, to compensate for increased wear with the increase in diameter. The floor of the grooves (1c) can be formed smooth to allow for limited slippage during tightening and removal. For attractive appearance or for identification, colored o-rings may be installed to suit the user. In addition, o-rings of various compounds can be selected for specific applications. For example, a compound which maintains resilience in low temperatures can be chosen when appropriate.

Operation

When the camera attachment plate (1A, see FIG. 1) is screwed onto camera underside (2), the resilient o-rings (1) are progressively compressed until the plate is tightened against the camera.

Should the upper surface of the o-ring encounter a surface irregularity on the camera underside (2), it is free to bind with it, further movement being allowed between the o-ring (1) and its smooth groove (1c), until the plate is securely tightened to the camera. As the o-ring is compressed during tightening, it presses against all three walls of the groove, as well as the camera underside-this assures a firm, non-slip engagement of the camera attachment plate with the camera.

1. In the field of panhead camera attachment plates having a central camera screw, a camera attachment area concentric to said screw, and a resilient means on said camera attachment area to secure an optical instrument to said camera attachment plate and protect said optical instrument from marring, the improvement wherein:
said resilient means comprises at least one groove formed in an upper surface thereon of said camera attachment plate, and substantially concentric with said central camera screw, said groove being dimensioned to accept a commercially available o-ring.

2. The improvement of claim 1, wherein said resilient means comprises a plurality of substantially concentric grooves, each successive groove dimensioned to provide for successively greater protrusion of said o-ring from said camera attachment area.

3. The improvement of claim 1, wherein said groove is dimensioned so that said o-ring is securely retained therein by its own elasticity.
